(19) United States
(12) Patent Application Publication
(10) Pub. No.: US 2010/0011970 A1
(43) Pub. Date: Jan. 21, 2010

(54) CHOCOLATE DEVICE FOR HOT COFFEE

(76) Inventor: AVRAHAM ASHER, Holon (IL)

Correspondence Address: Avraham Asher, 67 Elazar Street, Holon, 58481, IL

(21) Appl. No.: 12/176,389

(22) Filed: Jul. 20, 2008

(51) Int. Cl. A47J 31/00

(52) U.S. Cl. 99/323.3

(57) ABSTRACT

A single piece of chocolate, wherein at least one portion of the piece of chocolate is capable of being hangingly attached to a cup of a hot drink, such as coffee. The rest of the chocolate piece is hovering over the hot coffee and/or hot foam, whereas the heat exerting onto the hovering chocolate melts the chocolate into the steaming coffee.

### FIELD OF THE INVENTION

The present invention relates to a support for a chocolate piece accompanying a cup of coffee, and in particularly, the present invention relates to a chocolate piece accompanying a cup of coffee that can support itself and then melt into the hot coffee.

### BACKGROUND AND PRIOR ART

It is often desirable by coffee drinkers to add a piece of chocolate to their hot coffee. When coffee is served with an accompanying piece of chocolate place on the saucer next to the hot cup of coffee, the chocolate often melts in its wrapping before it can be used.

It is thus desirable to provide a method of serving a chocolate piece accompanying a hot cup of coffee, such that it will melt only into the cup.

### SUMMARY OF THE INVENTION

The object of the present invention is to provide a method of serving a chocolate piece accompanying a hot cup of coffee, such that it will melt only into the cup.

According to the teachings of embodiments of the present invention there is provided a single piece of chocolate, wherein at least one portion of the piece of chocolate is capable of being hangingly attached to a cup of a hot drink, such as coffee. The rest of the chocolate piece is hovering over the hot coffee and/or hot foam, whereas the heat exerting onto the hovering chocolate melts the chocolate into the steaming coffee.

An aspect of the present invention is to use the surfaces of the chocolate piece for promotion and adverting.

### BRIEF DESCRIPTION OF THE DRAWINGS

The present invention will become fully understood from the detailed description given herein below and the accompanying drawings, which are given by way of illustration and example only and thus not limitative of the present invention, and wherein:

FIG. 1 is a perspective view of a coffee cup having a piece of chocolate mounted onto the edge of the wall of the cup, according to embodiments of the present invention;

FIG. 2 is a top perspective view of a coffee cup having a piece of chocolate mounted onto the edge of the wall of the cup, according to embodiments of the present invention;

FIG. 3 is a perspective view of a coffee cup having a piece of chocolate mounted onto the edge of the wall of the cup in two locations, according to variations of the present invention;

FIG. 4 is a top perspective view of a coffee cup having a piece of chocolate mounted onto the edge of the wall of the cup in two locations, according to variations of the present invention; and

FIG. 5 is a perspective view of a coffee cup having a piece of chocolate held by a hanger, which is mounted onto the edge of the wall of the cup, according to embodiments of the present invention.

### DESCRIPTION OF THE PREFERRED EMBODIMENTS

Before explaining embodiments of the invention in detail, it is to be understood that the invention is not limited in its application to the details of construction and the arrangement of the components set forth in the host description or illustrated in the drawings.

Unless otherwise defined, all technical and scientific terms used herein have the same meaning as commonly understood by one of ordinary skill in the art of the invention belongs. The methods and examples provided herein are illustrative only and not intended to be limiting.

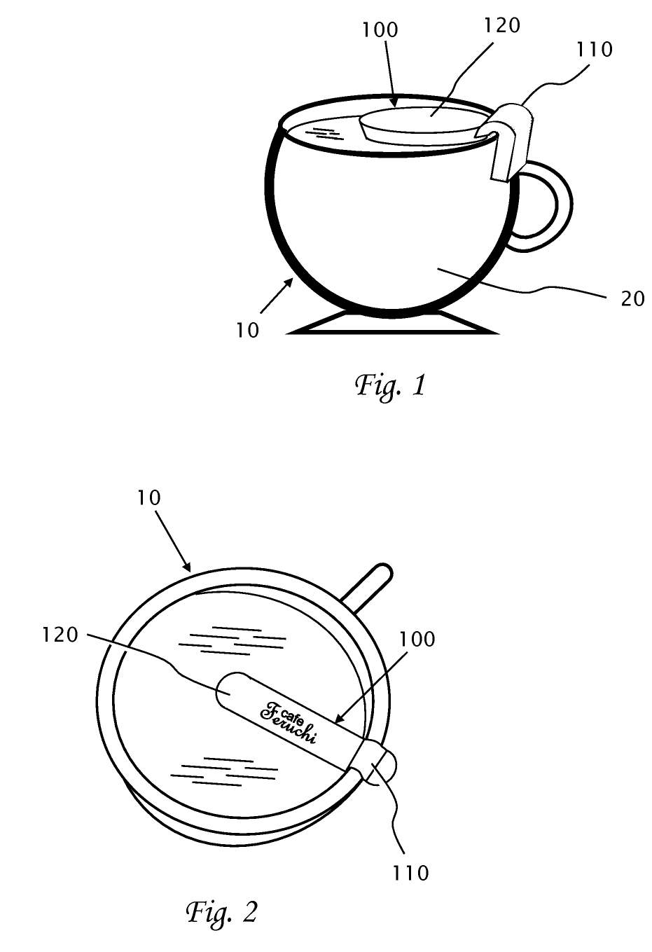

FIG. 1 is a perspective view of a coffee cup 10 having a piece of chocolate 100 mounted onto the edge of wall 20 of the cup 10, according to embodiments of the present invention. Piece of chocolate 100 includes a handle 110 built into piece of chocolate 100. FIG. 2 is a top perspective view of a coffee cup 10 having a piece of chocolate 100 mounted onto the edge of wall 20 of the cup 10, similar to the embodiment shown in FIG. 1.

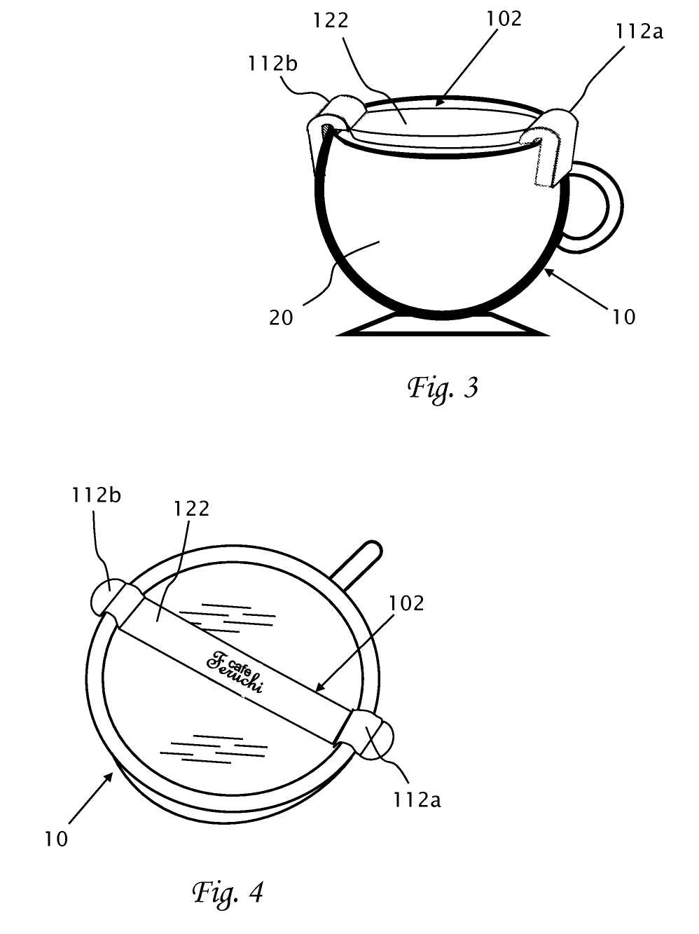

FIG. 3 depicts another embodiment of a piece of chocolate 102 mounted onto the edge of wall 20 of the cup 10 in two locations, according to variations of the present invention. Piece of chocolate 102 includes two handles 112 built into piece of chocolate 102, each of which is placed over the edge of wall 20 of cup 10. FIG. 4 is a top perspective view of a coffee cup 10 having a piece of chocolate 102 mounted onto the edge of wall 20 of the cup 10, similar to the embodiment shown in FIG. 3.

In variations of the present invention, piece of chocolate 102 may includes any number handles 112 built piece of chocolate 102. Handles 110 can be molded to fit any cup 10 or mug and can be made to fit a specific cup 10.

In the variation shown in FIGS. 3 and 4, the flat portion 122 may be higher above the upper surface of the coffee, such that it does not melt. Thereby, the user can decide whether to keep chocolate 102 for desert, simply remove it or have it melt into the coffee.

Piece of chocolate 100 includes a body 120, hovering over the upper surface of the hot coffee and/or hot foam, whereas the heat exerting onto the hovering chocolate melts chocolate piece 100 into the steaming coffee. Typically, chocolate piece 100 is designed to melt in about 30 seconds, but the present invention is not limited by it and chocolate piece 100 can be designed to melt in any length of time.

Body 120 and handle 110 can be produced in any shape and any width. For example, body 120 can be rectangular, elliptic, shape as a moon, have one or more holes, shaped as a flower, as a logo and so on and so forth.

In embodiments of the present invention the surfaces of chocolate piece 100 are used for promotion and advertisement. For example, the upper surface of body 120 and/or the external surface of handle 110 can have the logo of the coffee shop, where the coffee is being served.

It should be noted that the present invention is not limited in using chocolate piece 100 accompanying a hot coffee cup 10, but can be used to accompany any hot drinks, for example, hot chocolate.

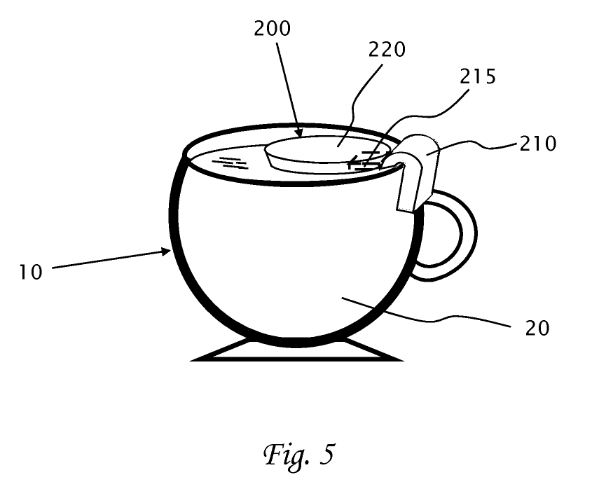

Reference is now made to FIG. 5, which is a perspective view of a coffee cup 10 having a chocolate assembly 200 including a generally flat piece of chocolate 220 firmly held by a hanger 210, wherein hanger 210, which is shaped as a hook, is mounted onto the edge of wall 20 of cup 10, according to embodiments of the present invention. Chocolate assembly 200 can be manufactured as a single piece, whereas flat chocolate part 220 is cast over holding part 215, which is part of hanger 210 and firmly holds chocolate piece 220 in ambient temperature or cooler temperatures. Hanger 210 and holding part 215 can be made of one piece, being a holding hanger. Holding part 215 can be made of plastic, wood, or any other material that is safe to contact with the chocolate and is temperature resistant. After serving, the heat of the coffee melts flat chocolate part 220, which slowly disconnect from holding part 215 and submerges into the coffee filling coffee cup 10.

Hanger 210 is shaped as a hook to firmly attach onto the edge of wall 20 of cup 10, wherein hanger 210 is affixed to flat piece of chocolate 220, and wherein hanger 210 keeps flat piece of chocolate 220 on top of the coffee which fills coffee cup 10. The width dimensions of hanger 210 can be of any width, covering one or more segments of the edge of wall 20 of cup 10. In variations of the present invention, the width of hanger 210 covers all the edge of wall 20 of cup 10.

In other embodiments of the present invention holding part 215 can be a clamp for holding flat chocolate piece 220 or any other holding mechanism.

In embodiments of the present invention hanger 210 and/or holding part 215 can be a flexible or hard candy.

In embodiments of the present invention hanger 210 and/or holding part 215 can be made of a flexible and adjustable material.

In all embodiments of the present invention the chocolate can be any type of chocolate. The chocolate can be with no additives or the chocolate may contain one or more additives such as nuts, almonds, rice puffs, cream fill or any other additive.

The invention being thus described in terms of embodiments and examples, it will be obvious that the same may be varied in many ways. Such variations are not to be regarded as a departure from the spirit and scope of the invention, and all such modifications as would be obvious to one skilled in the art are intended to be included within the scope of the claims.

What is claimed is:

1. A chocolate assembly for disposing on top of the coffee which fills a coffee cup, the chocolate assembly comprising:
a) a hanger portion for hanging the chocolate assembly onto said coffee cup; and
b) a generally flat portion to be disposed on top of the coffee which fills said coffee cup,
wherein said hanger is shaped as a hook to firmly attach onto the edge of the wall of said coffee cup;
wherein said hanger is affixed to said flat portion; and
wherein said hanger keeps said flat portion hovering over the upper surface of said coffee which fills said coffee cup for a predetermined period of time,
wherein after said predetermined period of time is the chocolate assembly melts into said coffee.

2. The chocolate assembly of claim 1, wherein said hanger and said flat portion, are made of a single piece of chocolate.

3. The chocolate assembly of claim 1, wherein said flat portion, is made of a single piece of chocolate comprising additives.

4. The chocolate assembly of claim 3, wherein said additives are selected from the group including nuts, almonds, rice puffs, cream fill or any other additive.

5. The chocolate assembly of claim 1, wherein said hanger and said flat portion, are made of separate pieces.

6. The chocolate assembly of claim 5 further comprising a holding part, wherein said holding part is part of said hanger, and wherein said flat portion is cast over said holding part.

7. The chocolate assembly of claim 1, wherein said predetermined period of time, is about 30 seconds.

8. The chocolate assembly of claim 1, wherein said hovering of said flat portion over said upper surface of said coffee is high enough, thereby enabling the user to remove the chocolate assembly before melting into said coffee.

9. The chocolate assembly of claim 5, wherein said hanger and said holding part, are made of a single piece, said piece being a holding hanger.

10. The chocolate assembly of claim 9, wherein said holding hanger is made of material selected from the group including wood, plastic, candy, flexible material, bendable material.

11. The chocolate assembly of claim 5, wherein said holding part is made of material selected from the group including wood, plastic, flexible material, bendable material.

12. The chocolate assembly of claim 5, wherein said holding part, is made a candy.

13. The chocolate assembly of claim 5, wherein said holding part is a clamp for holding said flat chocolate piece.
